(19) United States
(12) Patent Application Publication
(10) Pub. No.: US 2018/0083517 A1
(43) Pub. Date: Mar. 22, 2018

(54) Electric Motor And Armature thereof

(71) Applicant: Johnson Electric S.A., Murten (CH)

(72) Inventors: Yue LI, Hong Kong (CN); Mao Xiong JIANG, Shen Zhen (CN); You Qing XIANG, Shenzhen (CN); Chi Wai LAI, Hong Kong (CN); Ying Song YE, Shen Zhen (CN); Hai Jun HUA, Shen Zhen (CN); Ya Ming ZHANG, Shen Zhen (CN)

(21) Appl. No.: 15/707,056

(22) Filed: Sep. 18, 2017

(30) Foreign Application Priority Data
Sep. 18, 2016 (CN) 2016 1082 8092.1

(51) Int. Cl. H02K 15/02; H02K 11/22

(52) U.S. Cl. CPC H02K 15/026; H02K 11/022

(57) ABSTRACT

The present invention provides an electric motor which includes a stator and a rotor rotatable relative to the stator. The stator includes a stator core and a winding. The stator core includes a yoke and a plurality of teeth extending from the yoke. The winding is wound on the teeth. The stator further comprises a shielding member mounted to at least one axial end of the stator core, and at least one of opposite axial ends of the winding is completely covered by the shielding member. The electric motor of the present invention has a reduced electromagnetic interference (EMI) and improved electromagnetic compatibility (EMC).

### CROSS REFERENCE TO RELATED APPLICATIONS

This non-provisional patent application claims priority under 35 U.S.C. § 119(a) from Patent Application No. 201610828092.1 filed in The People's Republic of China on Sep. 18, 2016.

### FIELD OF THE INVENTION

The present invention relates to an electric field, and in particular to an electric motor and an armature.

### BACKGROUND OF THE INVENTION

A stator of a brushless motor usually comprises a stator core and a winding wound on the stator core. During operation of the motor, the winding generates a relatively large electromagnetic interference (EMI) due to change of the direction and value of current flowing through the winding, which results in the electromagnetic compatibility (EMC) of the motor not being good enough.

### SUMMARY OF THE INVENTION

In one aspect, the present invention provides an electric motor which includes a stator and a rotor rotatable relative to the stator. The stator includes a stator core and a winding. The stator core includes a yoke and a plurality of teeth extending from the yoke. The winding is wound on the teeth. The stator further comprises a shielding member mounted to at least one axial end of the stator core, and at least one of opposite axial ends of the winding is completely covered by the shielding member.

In another aspect, the present invention provides an armature which comprises a core and a wining. The core comprises a yoke and a plurality of teeth extending from the yoke. The winding is wound on the teeth. The winding has ends axially extending beyond the teeth. The armature further comprise a shielding member mounted to at least one axial end of the stator core, at least one of the ends of the winding are completely covered by the shielding member.

The electric motor of the present invention has a reduced EMI and improved EMC.

### BRIEF DESCRIPTION OF THE DRAWINGS

FIG. 1 is a perspective view of an electric motor according to one embodiment of the present invention.

FIG. 2 is an exploded view of the motor of FIG. 1.

FIG. 3 is a perspective view of a stator of the motor of FIG. 2.

FIG. 4 is an end plane view of the stator of FIG. 3.

FIG. 5 is a side view of the stator of FIG. 3.

FIG. 6 is a cross section view of the stator of FIG. 5 along line A-A.

The present invention will be further described below with reference to the accompanying drawings and the following embodiments.

### DETAILED DESCRIPTION OF THE PREFERRED EMBODIMENTS

Below, embodiments of the present invention will be described in greater detail with reference to the drawings. Elements of similar structures or functions are generally represented by like reference numerals for illustrative purposes throughout the figures. It should be noted that the figures are illustrative rather than limiting. The figures are not drawn to scale, do not illustrate every aspect of the described embodiments, and do not limit the scope of the present disclosure. Unless otherwise specified, all technical and scientific terms used in this disclosure have the ordinary meaning as commonly understood by people skilled in the art.

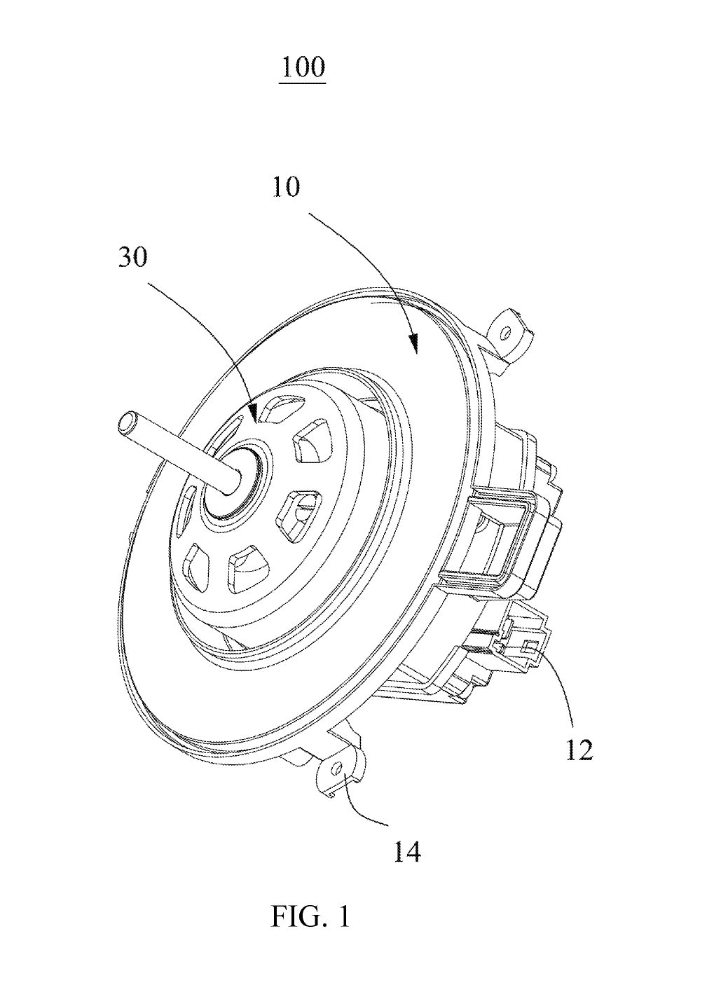

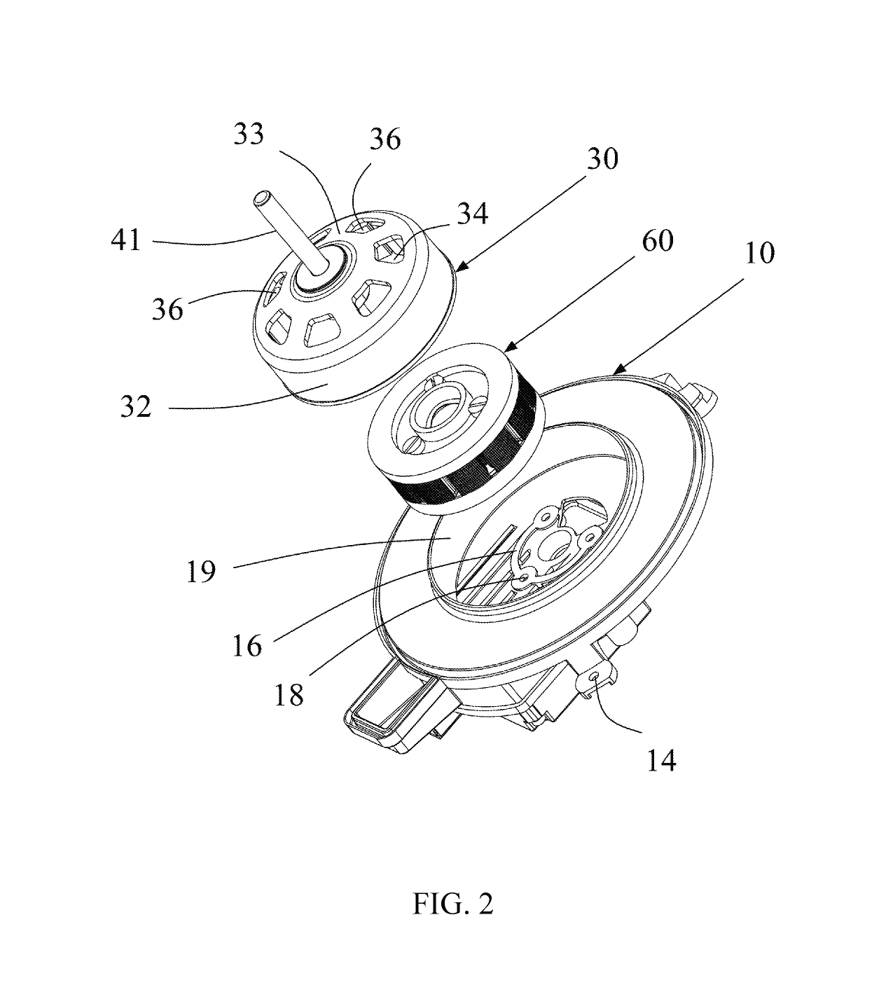

Referring to FIG. 1 and FIG. 2, an electric motor 100 in accordance with one embodiment of the present invention comprises a mounting bracket 10, a stator 60 fixed to the mounting bracket 10, and a rotor 30 rotatably mounted to the mounting bracket 10 or the stator 60. A circuit board with motor drive circuits mounting thereon and terminals 12 for connecting the circuit board to an outside power source may be installed in the mounting bracket 10. The mounting bracket 10 further comprises a plurality of connecting arms 14 each having a mounting hole defined therein. The connecting arms 14 are for connecting the mounting bracket 10 to a workstation.

Understandably, the stator 60 and the mounting bracket 10 are fixed together and thus can be considered as an integral structure.

In the embodiment, the motor 100 is an outer rotor type brushless motor. The rotor 30 and the stator 60 are respectively an excitation and an armature of the motor 100. The rotor 30 comprises a cylindrical casing 32, one or more permanent magnets 36 fixed to the inner surface of the casing 32, and a shaft 41 fixed to the casing 32. The casing 32 has a U-shaped cross section and comprises a bottomed end 33 fixed with the shaft 41 and an open end with an opening for entering of the stator 60 into the casing 32. Preferably, the bottomed end 33 of the casing 23 forms through holes 34 for allowing airflow to pass through the casing 32 to thereby cool the motor. The casing 32 is made of a magnetic conductive material.

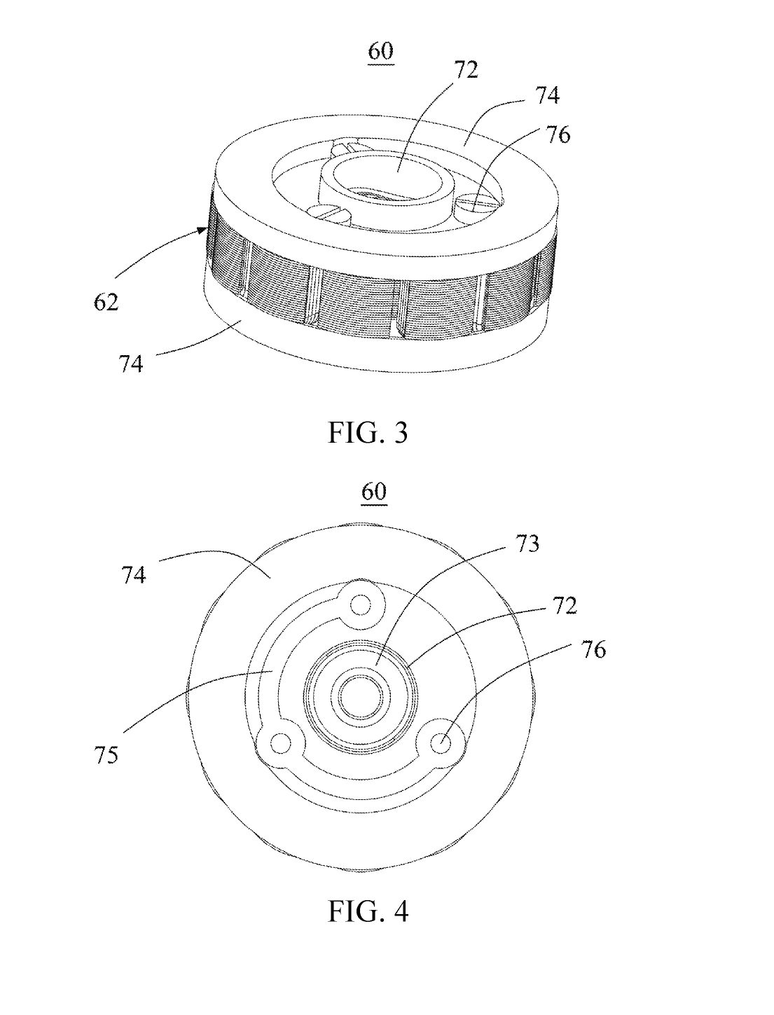

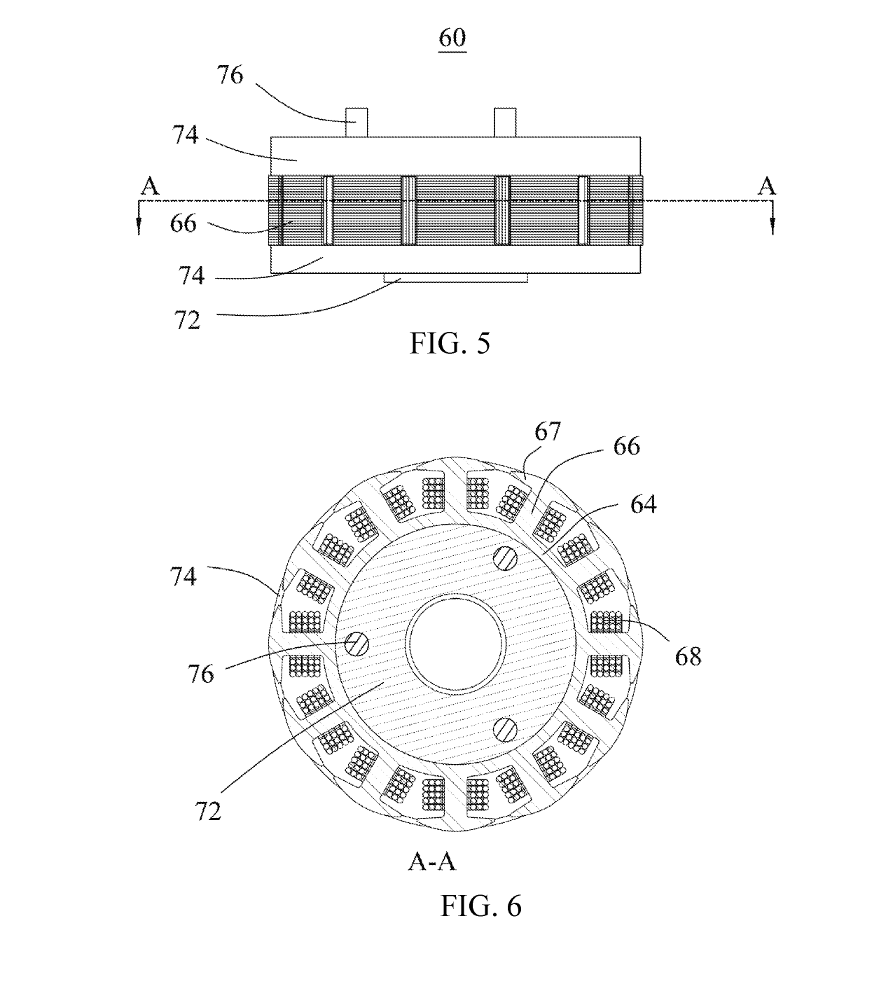

Referring to FIGS. 3-6, the stator 60 comprises a stator core 62 (see FIG. 3) and a winding 68 (see FIG. 5). The stator core 62 comprises a yoke 64 and a plurality of teeth 66 (see FIG. 6) extending outwardly from the yoke 64. Each tooth 66 has a crown formed at an end away from the yoke 64. The winding 68 is wound around the teeth 66. Effective sides of the winding 68 are respectively received in spaces formed between the yoke 64 and adjacent teeth 66.

The stator 60 further comprises a pair of shielding members 74 respectively mounted on opposite axial ends of the stator core 62. The shielding member 74 is made of a non-ferromagnetic material with low resistance, such as copper or aluminum. Preferably, the shielding member 74 is made of a copper foil or an aluminum foil. The shielding members 74 form a shielding space therebetween and the windings 68 are located in the shielding space. That is, the exposed ends of the windings 68 extending axially beyond the teeth 66 are covered by the shielding members 74, which reduces EMI from the windings 68. Preferably, the shielding members 74 are grounded to improve the shielding effect. Alternatively, it is possible to use only one shielding member 74 according to design requirement.

In the embodiment, the stator 60 further comprises a support member 72 which is hollow tube-shaped. The support member 73 is mounted around the shaft 41 via bearings 73 such that the shaft 41 is rotatable relative to the support member 72. The yoke 64 of the stator core 62 is annular-shaped and fixed to the outer surface of the support member 72. The shielding members 74 respectively define a through hole to expose the support member 72. Specifically, the two shielding members 74 are connected together and tightly sandwiches the stator core 62 via a plurality of fasteners 76, e.g. threaded rods. The fasteners 76 are made of electrically conductive material and therefore electrically connect the two shielding members 74. The stator 60 further comprises washers 75, which is also made of electrically conductive material, mounted between the fasteners 76 and the shielding members 74. The washers 75 are connected between the fasteners 76 and tightly press against the shielding members 74 to ensure the electrically connection. Thus, the shielding members 74 are electrically connected with each other reliably via the plurality of fasteners 76 and the washers 75. Therefore, when one of the shielding members 74 is grounded all shielding members 74 are grounded. For example, when using a wire to connect one of the shielding members 74 and a grounding terminal the two shielding members 74 are grounded. In one embodiment, the circuit board mounted in the mounting bracket 30 has the grounding terminal.

In an alternative embodiment, the support member 72 is made of an electrical conductive material. The two shielding members 74 are respectively mounted to opposite ends of the support member 72 and thus electrically connected to the support member 72. In this alternative embodiment, the support member 72 electrically connects the two shielding members 74 to thereby facilitate grounding of the two shielding members 74.

In one embodiment, the support member 72 and the stator core 62 are separately formed. Understandably, the support member 72 and the stator core 62 may be formed as an integral structure.

Referring to FIG. 2, the mounting bracket 10 has a washer 16 mounted therein. Fasteners 76 extend through the washer 16 and connect with the mounting bracket 10 to thereby mount the stator 60 to the mounting bracket 10 and electrically connecting the shielding members 74 and the washer 16 which are grounded.

In the present invention, the shielding members 74 cover most areas of the opening of the casing 32. Thus, the shielding members 74 and the casing 32 cooperatively form a good shielding cover which reduces the electromagnetic interference (EMI) of the windings 68 and improve the electromagnetic compatibility (EMC) of the motor. Preferably, the mounting bracket 10 comprises a chamber 19 with one open end and the open end of the casing 32 is received in the chamber 19 with the orientation of the open end of the chamber 19 is reverse to that of the casing 32. Thus, the EMI from the winding 68 is further reduced and the EMC of the motor is further improved.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. An electric motor comprising:
a stator comprising a stator core and a winding, the stator core comprising a yoke and a plurality of teeth extending from the yoke, the winding wound on the teeth; and
a rotor rotatable relative to the stator;
wherein the stator further comprises a first shielding member mounted to one of opposite axial ends of the stator core, and one of opposite axial ends of the winding is completely covered by the first shielding member, the first shielding member is ground.

2. The electric motor of claim 1, wherein the stator further comprises a second shielding member, the first and second shielding members being respectively mounted to the two opposite axial ends of the stator core, the second shielding member is ground.

3. The electric motor of claim 2, wherein the first and second shielding members are connected together and cooperatively sandwich the stator core therebetween via a plurality of fasteners.

4. The electric motor of claim 3, wherein the fasteners are made of an electrically conductive material, and the shielding member and the another shielding member being electrically connected with each other via the fasteners.

5. The electric motor of claim 4, wherein the stator further comprises washers mounted between the fasteners and the shielding members, the washers are made of electrically conductive material, the washers are connected between the fasteners and tightly press against the shielding members to ensure the electrically connection.

6. The electric motor of claim 2, wherein the stator further comprises a support member, the yoke are mounted around the support member, the shielding members respectively define a through holes to expose the support member.

7. The electric motor of claim 6, wherein the support member is made of electrically conductive material, and the first and second shielding members are engaged with the support member to enable the electrical connection between the first and second shielding members via the support member.

8. The electric motor of claim 1, wherein the shielding member is made of a non-ferromagnetic material with low resistance.

9. The electric motor of claim 8, wherein the shielding member is made of copper or aluminum.

10. The electric motor of claim 1 being an outer rotor type motor, wherein the rotor comprises a casing, one or more permanent magnets mounted on an inner surface of the casing and a shaft fixed to and extending through the casing, and the stator is received in the casing and mounted around the shaft.

11. The electric motor of claim 10, wherein the casing comprises a bottomed end fixed with the shaft and an open end with an opening for entering of the stator into the casing.

12. The electric motor of claim 11 further comprising a mounting bracket, wherein the stator is fixedly mounted to the mounting bracket, the mounting bracket comprises a chamber with an open end, the open end of the casing is received in the chamber, and the orientation of the open end of the chamber is reverse to that of the open end of the casing.

13. The electric motor of claim 12, wherein a circuit board with motor driving circuits is mounted in the mounting bracket, the circuit board has a grounding terminal, and the shielding member is electrically connected to the grounding terminal.

14. An armature comprising:
a core comprising a yoke and a plurality of teeth extending from the yoke;
a winding wound on the teeth, the winding having ends axially extending beyond the teeth; and
a shielding member mounted to at least one axial end of the stator core,
wherein at least one of the ends of the winding is completely covered by the shielding member.

15. The armature of claim 14, wherein the shielding member is grounded.

16. The armature of claim 14, further comprising another shielding member, wherein the shielding member and the another shielding member are respectively mounted to two axial ends of the stator core to completely cover the opposite axial ends of the winding, the two shielding member are connected together via fasteners.
